(19) United States
(12) Patent Application Publication
(10) Pub. No.: US 2025/0369841 A1
(43) Pub. Date: Dec. 4, 2025

(54) DILUTING A GAS SAMPLE

(71) Applicant: Saudi Arabian Oil Company, Dhahran (SA)

(72) Inventors: Sattam S. Mutairi, Khobar (SA); Abdullah M. Alhajri, Dhahran (SA); Salman Mohammed Qathami, Dammam (SA); Ahmad Al Mashama, Dhahran (SA)

(21) Appl. No.: 18/676,899

(22) Filed: May 29, 2024

(51) Int. Cl. G01N 1/38

(52) U.S. Cl. CPC G01N 1/38; G01N 2001/386

(57) ABSTRACT

A hand-portable gas sampling and dilution system includes a hand-portable case and a dilution system. The hand-portable case has a first side and a second side hingedly coupled to the first side, a retractable handle coupled to the first side proximal the carry handle, and a pair of wheels couple to the hand-portable case opposite the carry handle and the retractable handle. The carry handle has a first portion coupled to the first side of the hand-portable case and a second portion coupled to the second side of the hand-portable case. The first portion and the second portion mate when the first side and second side are closed together. The dilution system is positioned in the hand-portable case and coupled to an inner surface of the first side. The dilution system mixes a dilution gas with a sample gas to form a diluted sample.

### TECHNICAL FIELD

This disclosure relates to diluting a gas sample in the field, especially, for example, with a hand-portable gas sampling and dilution system in an oilfield setting.

### BACKGROUND

Hydrocarbons are trapped in reservoirs in subterranean formations of the Earth. Wellbores are drilled through subterranean formations to those reservoirs and completed to produce the hydrocarbons to the surface of the Earth. The produced hydrocarbons can be stored at the surface in storage facilities, transported to intermediate processing facilities, or transported to downstream refining facilities for further refinement. Some of the storage facilities or intermediate processing facilities can be in remote locations of the oilfield. Sometimes, a sample of the hydrocarbons can be drawn and analyzed by an oilfield worker at the remote location.

### SUMMARY

This disclosure describes technologies related to diluting a gas sample at a remote oilfield location. The gas sample is diluted using a hand-portable gas sampling and dilution system and provided to a sample chamber. The hand-portable gas sampling and dilution system can be easily moved, maneuvered, and used in the oilfield. The hand-portable gas sampling and dilution system has a hand-portable case enclosing a dilution system. The hand-portable case has a first side and a second side hingedly coupled to the first side. The hand-portable case has a carry handle, a retractable handle, and a pair of wheels. The carry handle has a first portion and a second portion. The first portion of the carry handle is coupled to the first side of the hand-portable case and the second portion of the carry handle is coupled to the second side of the hand-portable case. The first portion of the carry handle and the second portion of the carry handle mate when the first side and second side are closed together. The retractable handle coupled to the first side proximal the carry handle. The pair of wheels are coupled to the hand-portable case opposite on the opposite side from the carry handle and the retractable handle. The dilution system is positioned in the hand-portable case and coupled an inner surface of the first side of the hand-portable case. The dilution system mixes a dilution gas with a sample gas to form a diluted sample.

Implementations of the present disclosure can realize one or more of the following advantages. For example, this approach can reduce downtime in oilfield drilling, completion, and production operations. Some gas samples from oil wells and production facilities contain gases at concentrations which exceed an instrument's or a sensor's ability to quantify. In other cases, an operator may be concerned that a level of a gas exceeds a safe level to sample. In these cases, operations may be stopped while a gas sample is drawn, transported to a laboratory, and tested in the laboratory to determine if operations may proceed. By diluting the sample at the site of operations using a ratio of dilution gas to a level which may be sensed by onsite instruments, or to a level which is safe for personnel and instruments, operations down time can be reduced. For example, some instruments require lower concentrations of captured gas samples to accurately measure the constituent gases and properties. Natural gas samples can contain several components such as methane, ethane, propane. Some onsite field gas analyzers are sensitive to high concentrations of methane, so the hand-portable field dilution assembly of this present disclosure can reduce the concentrations by a pre-selected dilution ratio.

This approach can also improve sampling accuracy. For example, by connecting the instrument directly to a diluted gas sample, open sampling of gases can be eliminated, reducing contamination and imprecise dilution of off-gassing vapors. For example, by using the gas sampling and dilution system, gas samples are no longer exposed to harsh weather conditions such as heat, cold, dusty, and rainy climates. Such conditions affect the gas samples causing the addition of contamination into the samples. Eliminating open space sampling can improve sampling accuracy.

This approach can improve personnel safety. For example, by eliminating open space sampling, personnel contact with gases is reduced, improving personnel safety. By eliminating open space sampling, which can lead to cause blowouts, fire, or even leakage of toxic gases which can harm personnel, worker safety can be improved. For example, reducing concentrations of gases to lower levels, and in some cases, below minimum long term exposure levels, personnel health and safety can be improved.

This approach can also increase sampling frequency. For example, a single remote site can be sampled with increased frequency by diluting additional samples with less time between sampling intervals.

This approach can also increase the number of oilfield locations which can be sampled. For example, previous oilfield locations which were too remote or isolated for laboratory sampling to be performed can now be sampled with the hand-portable gas sampling and dilution system.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic view of a hand-portable gas sampling and dilution system within an opened hand-portable case.

FIG. 2 is a schematic view of the outside top and bottom surfaces of the hand-portable case of FIG. 1.

FIG. 3 is a schematic view of the outside of the hand-portable case of FIG. 1.

FIG. 4 is schematic view of the outside of the hand-portable case of FIG. 1 with a retractable handle in an extended position.

FIG. 5 is a schematic view of a dilution assembly of the hand-portable gas sampling and dilution system of FIG. 1 with a protective sheet removed from within the hand-portable case.

FIG. 6 is a schematic view of the dilution assembly aligned to draw an undiluted gas sample.

FIG. 7 is a schematic view of the dilution assembly aligned to flow a dilution gas through the dilution system.

FIG. 8 is a schematic view of the dilution assembly aligned to mix a diluted sample.

FIG. 9 is another schematic view of the outside top and bottom surfaces of the hand-portable case of FIG. 1.

### DETAILED DESCRIPTION

The present disclosure describes systems and methods for diluting a gas sample in an oilfield setting. Sometimes, concentration of a gas sample or a concentration of a specific gas in a gas sample is required to be reduced at a remote oilfield location to enable measurement of the properties of the gas sample. These systems and methods can enable dilution of the sample gas at the remote oilfield location using a hand-portable gas sampling and dilution system in a hand-portable case. The hand-portable case has a first side and a second side coupled to the first side. The hand-portable case has a carry handle with a first portion and a second portion. The first portion of the carry handle is coupled to the first side of the hand-portable case and the second portion of the carry handle is coupled to the second side of the hand-portable case. When the first side and second side are closed together the first portion and the second portion mate to form the carry handle. The hand-portable case has a retractable handle coupled to the first side proximal the carry handle. The hand-portable case has a pair of wheels. The pair of wheels are coupled to the hand-portable case on the opposite side from the carry handle and the retractable handle. The hand-portable gas sampling and dilution system has a dilution system positioned in the hand-portable case and coupled an inner surface of the first side of the hand-portable case and mixes a dilution gas with a sample gas to form a diluted sample.

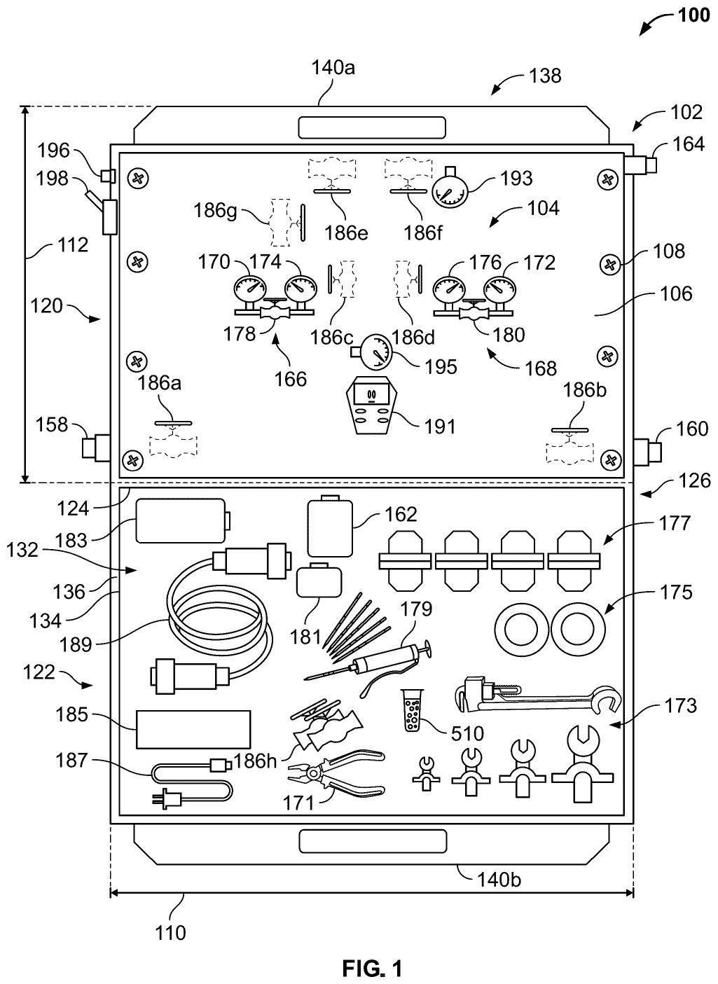

Referring to FIGS. 1-3, the hand-portable gas sampling and dilution system 100 is used to collect and dilute fluid samples, especially gas, from oil wells during drilling, completion, and production operations. For example, some of the facilities wellheads on wellbores, gas plants, gas separators, and pipelines manifolds in the field. Some of the oil wells are located in remote regions far from laboratories or major refining facilities. Collecting and analyzing the fluids are critical to the understanding of essential elements of petroleum drilling, completion, and production systems status and are necessary for safe and continued operations. Fluids, in the form of both liquids and gases, can include some of the most dangerous forms of organic gases due to their physical and chemical characteristics. For example, physical characteristics of the gases include the high pressure and high temperature nature of the gases. The chemical aspects of the fluids can include toxic compounds in gaseous form (i.e., hydrogen sulfide (H₂S), carbon dioxide (CO₂), and carbon monoxide (CO). Sampling such gases typically requires extensive training and protective equipment during sampling operations to minimize human contact with the gases. Diluting the gas sample with the hand-portable gas sampling and dilution system in the field enables safe sampling and analysis by oilfield workers.

The hand-portable gas sampling and dilution system 100 includes the dilution assembly 104 positioned in the hand-portable case 102. The dilution assembly 104 mixes a dilution gas with a sample gas to form a diluted sample. The hand-portable case 102 protects the dilution assembly 104.

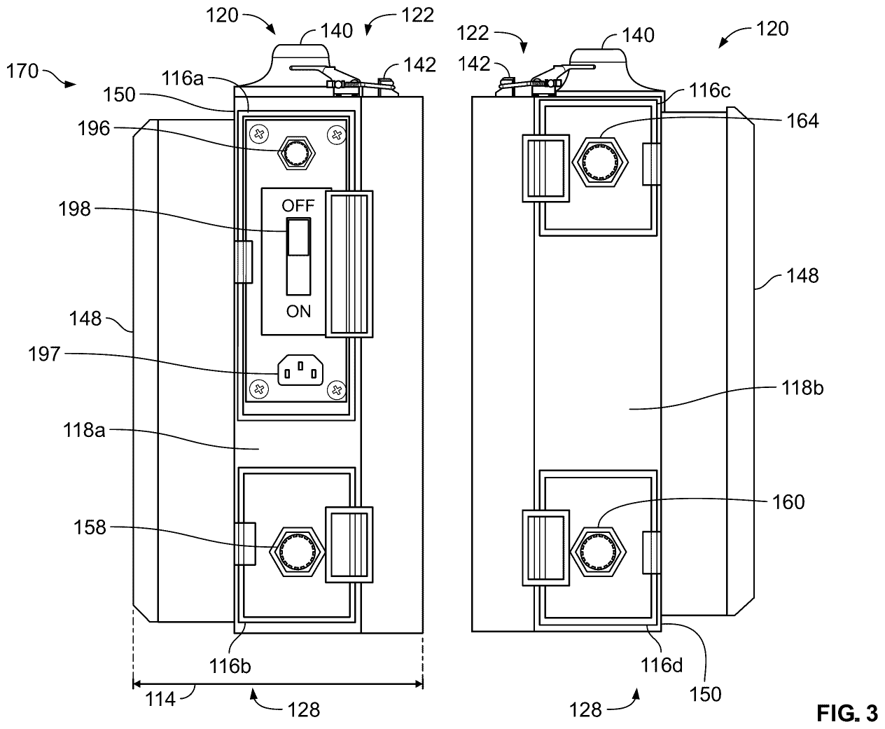

The hand-portable case 102 has overall dimensions that facilitate movement, transportation, setup, use, and takedown in the field, while protecting the dilution assembly 104 and other contents of the hand-portable case from the oilfield environment, like a large briefcase. For example, the operator can easily move the hand-portable gas sampling and dilution system 100 in and out of a vehicle door. The hand-portable case 102 has a length 110, a width 112, and a height 114 (shown in FIG. 3). In this embodiment, the length 110 of the hand-portable case 102 is approximately thirty-five inches. In other embodiments, the maximum length 110 is thirty-five inches. In other embodiments, the length 110 can be between twenty five inches and forty inches. However, any suitable length 110 can be used. In this embodiment, the width 112 of the hand-portable case 102 is approximately twenty-seven and a half inches. In other embodiments, the maximum width 112 is twenty-seven and a half inches. In other embodiments, the width 112 can be between twenty five inches and forty inches. However, any suitable width 112 can be used. In this embodiment, the height 114 of the hand-portable case 102 is approximately fourteen inches. In other embodiments, the maximum height 114 is fourteen inches. In other embodiments, the height 114 can be between ten inches and twenty inches. However, any suitable height 114 can be used. In some embodiments, various components (described below in more detail) may extend or be extendable beyond the maximum dimensions of the hand-portable case 102. In some implementations, the on/off switch 198 extends a maximum of 1.2 inches from the hand-portable case 102. In some implementations, the 158, the 160, and the 164 extend a maximum of one inch from the hand-portable case 102. In some implementations, the wheels 146 extend a maximum of two inches from the hand-portable case 102.

The hand-portable gas sampling and dilution system 100 has a weight. The total weight of the hand-portable gas sampling and dilution system 100 is such that the hand-portable gas sampling and dilution system 100 can be safely lifted and carried or wheeled by one man. In this embodiment, the weight of the hand-portable gas sampling and dilution system 100 is approximately twenty six and a half pounds. In other embodiments, the weight can be between twenty pounds and thirty five pounds.

The hand-portable case 102 is constructed to protect the dilution assembly 104 from damage such as shock, crushing forces, and weather. For example, external weather and environmental conditions such as heat, cold, dust, and rain can damage the dilution assembly 104 causing corrosion or contaminating gas samples. For example, the hand-portable case 102 can experience shock from a drop or an impact from an external object. The hand-portable case 102 can be constructed from a material such as a hard plastic (i.e., a high density polyethylene (HDPE)) or metal (i.e., aluminum, titanium, steel, or alloy). The entire hand-portable case 102 is fully covered by a layer of foam, which is then further covered with a rippled rubber outer layer. The outer layers of foam and ripple rubber further protect the dilution assembly 104 and the other components contained within the hand-portable case 102 from corrosion and impact.

Referring to FIG. 3, the hand-portable case 102 has multiple protective covers 116a-116d coupled to the outer side surfaces 118a, 118b of the hand-portable case 102. The protective covers 116a-116d seal to the outer side surfaces 118a, 118b to protect features of components that extend through the hand-portable case 102 from contamination or impact. The protective covers 116a-116d can be coupled to the outer side surfaces 118a, 118b by hinges and latches. The protective covers 116a-116d can be constructed from a material such as a hard plastic (i.e., a high density polyethylene (HDPE)) or metal (i.e., aluminum, titanium, steel, or alloy).

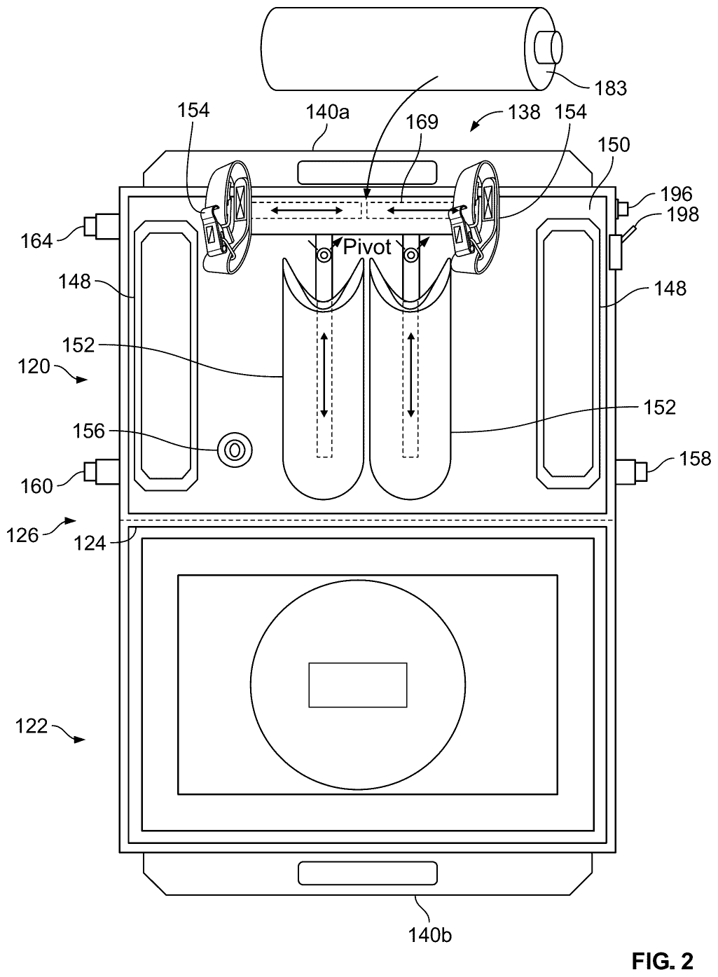

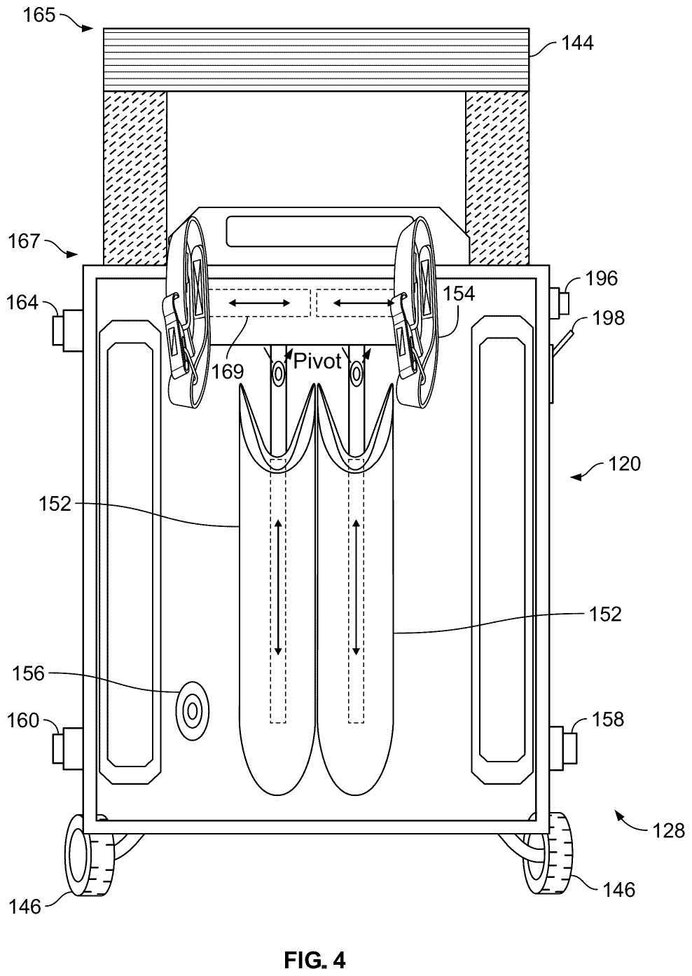

Referring to FIGS. 1-4, the hand-portable case 102 has a first side 120 and a second side 122. The first side 120 and the second side 122 are coupled together and rotate about a hinge 124. The hand-portable case 102 is a clamshell design. The first and second sides 120, 122 rotate about the hinge 124 between an open position 126 shown in FIGS. 1 and 2, and a closed position 128 as shown in FIGS. 3 and 4.

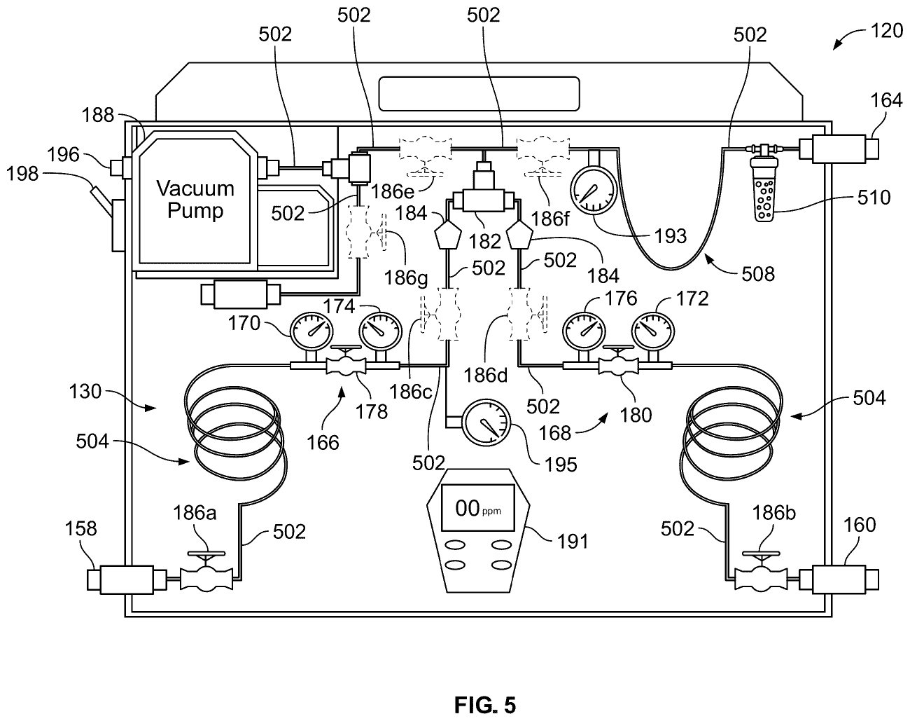

The first side 120 defines a first cavity 130 (shown in FIGS. 5-8) and the second side 122 defines a second cavity 132 (shown in FIG. 1). The dilution assembly 104 is positioned within the first cavity 130 of the first side 120. Various other components and accessories of the hand-portable gas sampling and dilution system 100 are positioned within the second cavity 132 of the second side 122.

The hand-portable case 102 has an o-ring 134 around the edge 136 of the one or both of the first side 120 and the second side 122. When the first side 120 and the second side 122 are moved from the open position 126 to the closed position 128 about the hinge 124 to contact one another, the o-ring 134 forms a watertight seal from outside the hand-portable case 102 to prevent fluid and particulates from ingressing into the hand-portable case 102.

The hand-portable case 102 is vacuum sealable. When the first side 120 and the second side 122 are coupled together, the dilution assembly 104 can evacuate gases and particulates from the hand-portable case 102 and draw a vacuum within the hand-portable case 102.

The hand portable case 102 has clasps 142 (shown in FIG. 3) spanning the first side 120 and the second side 122 to couple the first side 120 and the second side 122 opposite the hinge 124. The clasps 142 are operable by the user to optionally lock the first side 120 to the second side 122.

The hand-portable gas sampling and dilution system 100 has a carry handle 138 having a first portion 140a and a second portion 140b. The first portion 140a is coupled to the first side 120 of the hand-portable case 102 and the second portion 140b is coupled to the second side 122 of the hand-portable case 102. When the first side 120 and second side 122 are closed together, the first portion 140a and the second portion 140b mate to form the carry handle 138. The carry handle 138 is sized to accept a person's hand and allow the hand-portable gas sampling and dilution system 100 to be carried in the field. In some implementations, the carry handle 138 can be a single portion and only coupled to the first side 120.

Referring to FIG. 4, the hand-portable gas sampling and dilution system 100 has a retractable handle 144 coupled to the first side 120 proximal the carry handle 138 and a pair of wheels 146 coupled to the first side 120 opposite the carry handle 138 to allow the hand-portable gas sampling and dilution system 100 to be transported by easily wheeling and maneuvering the hand-portable case 102 in different settings. The retractable handle 144 can slide between a stored position 167 within the hand-portable case 102 and an extended position 165. When the retractable handle 144 is in the extended position 165, the operator can hold the retractable handle 144 and provide leverage to tilt the hand-portable case 102, transferring the weight of the hand-portable gas sampling and dilution system 100 onto the pair of wheels 146, allowing the hand-portable gas sampling and dilution system 100 to be moved by hand easier for longer durations. In this implementation, the retractable handle 144 can extend ten inches from the hand-portable case 102, however, in other implementations, the retractable handle 144 can extend more or less ten inches from the hand-portable case 102. The retractable handle 144 has a width of approximately fifteen inches.

Referring to FIGS. 2-4, the hand-portable gas sampling and dilution system 100 has a pair of anti-vibration legs 148 on an outer surface 150 of the first side 120. The anti-vibration legs 148 extend along the width 112 and reduce transmission of vibration to and from the ground when the hand-portable case 102 is placed on the ground. The anti-vibration legs 148 can have a rippled surface to hinder sliding and movement of the hand-portable gas sampling and dilution system 100.

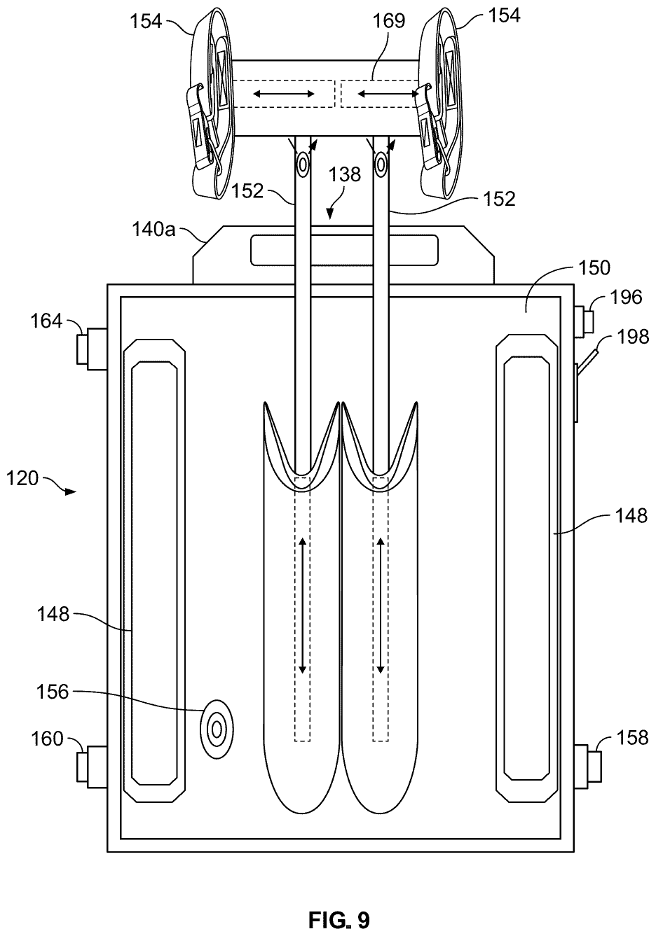

Referring to FIGS. 2, 4, and 9 the hand-portable gas sampling and dilution system 100 has a pair of retractable legs 152 coupled to the outer surface 150 of the first side 120. The retractable legs 152 are extendable and rotatable to elevate the hand-portable case 102 above the ground so the user can operate the dilution assembly 104 from a standing position. The pair of retractable legs 152 can have a rippled surface to hinder sliding and movement of the hand-portable gas sampling and dilution system 100. As shown in FIGS. 2 and 4, the pair of retractable legs 152 are in the retracted position. As shown in FIG. 9, the pair of retractable legs 152 are in the extended position.

The hand-portable gas sampling and dilution system 100 has a pair of straps 154 coupled to the outer surface 150 of the first side 120. The pair of straps 154 are adjustable to hold the sample container 183 external to the hand-portable case 102. The hand-portable gas sampling and dilution system 100 station has extendable arms 169 to safely hold the sample container 183. The extendable arms 169 are adjustable to hold and protect different sizes of sample containers 183.

The hand-portable gas sampling and dilution system 100 has a pressure balance button 156 positioned on the outer surface 150 of the first side 120. The pressure balance button 156 extends through the first side 120 to the space outside the hand-portable case 102 to relieve a buildup of pressure or humidity from within the hand-portable case 102. For example, the user can depress the pressure balance button 156 to balance or release pressure and water or humidity from within the hand-portable case 102 when the user transports the hand-portable gas sampling and dilution system 100 during air travel or long-distance car travels (i.e., changes in pressure and environmental humidity due to location or elevation changes).

The dilution system 104 mixes a dilution gas with a sample gas to form a diluted sample. Referring to FIGS. 1-8, dilution system 104 positioned in the hand-portable case 102 and coupled an inner surface (shown in FIG. 5) of the first side 120. Referring to FIG. 1, the hand-portable case 102 has a metal sheet 106 coupled to an inner portion of the first side 120 by screws 108 to seal portions of the dilution assembly 104 within the first cavity 130, but allow some components for operation and monitoring of the mixing and dilution process to be conducted. The metal sheet 106 creates a vacuum sealable volume within the first cavity 130 to remove any leaked contaminates or sample gases having toxic chemicals, improving personnel safety. For example, after a dilution and sampling operation, the first cavity 130 can be evacuated to remove contaminates before the operator stores the hand-portable gas sampling and dilution system 100 and travels to a new sampling location in the field. In this implementation, the metal sheet 106 is a stainless-steel sheet having a thickness of approximately two centimeters, however, any suitable material and thickness may be used. This implementation, the inner surface of the first cavity 130 is further coated with metal, for example, a partial steel shell and so the partial steel shell in the first cavity 130 and the metal sheet 106, when coupled, define in an internal metal boundary which is vacuum sealable.

The dilution assembly 104 has a sample gas inlet 158 which is couplable to an oilfield system (wellheads on wellbores, gas plants, gas separators, and pipelines manifolds in the field) to receive the sample gas to be sampled or diluted, a dilution gas inlet 160 which is couplable to a dilution gas source 162 containing the dilution gas to receive and pass the dilution gas into the dilution assembly 104, and a diluted sample outlet 164 to couple to a gas analyzer or gas container to pass the diluted sample, after mixing and dilution, to the gas analyzer or gas container. The sample gas inlet 158, the dilution gas inlet 160, and the diluted sample outlet 164 are threaded to attach to the oilfield system desired to be sampled, the dilution gas source 162, and/or the gas analyzer or gas container. For example, the sample gas inlet 158, the dilution gas inlet 160, and the diluted sample outlet 164 can be ¼ inch, ⅜ inch, or ½ inch threaded couplings. The sample gas inlet 158, the dilution gas inlet 160, and the diluted sample outlet 164 extend from within the first cavity 130 to outside the hand-portable case 102. The sample gas inlet 158, the dilution gas inlet 160, and the diluted sample outlet 164 are protected outside the hand-portable case 102 by the protective covers 116b, 116d, and 116c, respectively. The dilution gas can be an inert gas such as nitrogen or air, however, any suitable dilution gas can be used.

The dilution assembly 104 has a first dual-stage gas regulator 166 fluidly coupled to the sample gas inlet 158 to control a flow of the sample gas from the sample gas inlet 158 and a second dual-stage gas regulator 168 coupled to the dilution gas inlet 160. The first dual-stage gas regulator 166 decreases the pressure of the sample gas provide downstream to the diluted sample outlet 164. The second dual-stage gas regulator 168 decreases the pressure of the dilution gas provide downstream to the diluted sample outlet 164. For example, the pressure of the mixture of the sample gas to the dilution gas can be decreased based on the required pressure of the sampling instrument. The first dual-stage gas regulator 166 and the second dual-stage gas regulator 168 control the flow of the sample gas and the dilution fluid, respectively. Based on the position of the first dual-stage gas regulator 166 and the second dual-stage gas regulator 168, the ratio of the sample gas to the dilution gas at the diluted sample outlet can be altered. For example, the ratio of the sample gas to the dilution gas can be increased or decrease based on the required ratio by the sampling instrument. Adjusting the ratio of the sample gas to the dilution gas decreases the level of components of the sample gas within the detection ranges of the gas analyzers and the true concentrations in the sample gas from the oilfield system can then be calculated based on the dilution ratio. For example, using pressure and volume equations (PV=nRT), the sample gas concertation and dilution parameters before diluting the gas samples can be determined.

Each of the first dual-stage gas regulator 166 and the second dual-stage gas regulator 168 have an inlet gas pressure gauge 170, 172, respectively, to read the initial pressure (input pressure). For example, when the oilfield system is coupled to the dilution system 104 by the sample gas inlet 158, first dual-stage gas regulator 166 can receive the sample gas and the inlet gas pressure gauge 170 senses the sample gas pressure from the oilfield system. For example, when the dilution gas source 162 is coupled to the dilution system 104 by the dilution gas inlet 160, second dual-stage gas regulator 168 can receive the dilution gas and the inlet gas pressure gauge 172 senses the dilution gas pressure in the dilution gas source 162.

Each of the first dual-stage gas regulator 166 and the second dual-stage gas regulator 168 have an outlet gas pressure gauge 174, 176, respectively, to read the final pressure (outlet pressure). Each of the first dual-stage gas regulator 166 and the second dual-stage gas regulator 168 have a pressure control valve (i.e., a pressure reducing valve) 178, 180. In this implementation, the pressure control valves 178, 180 are manual valves (i.e., hand-operated or throttleable between an open and closed position to adjust the outlet pressure). In other implementations, the pressure control valves 178, 180 are automatically controlled by a controller to produce the desired output pressure and ratio. The outlet gas pressure gauges 174, 176 sense and read the outlet press of the respective pressure control valve 178, 180.

The dilution ratio can be determined based on the intended gas sample concentrations. For example, if the gas sample has an 80% volume of methane gas, then this concentration can be lowered by adding three times more volume of the dilution gas. This is accomplished by lowering the pressure of the sample gas using the first dual-stage gas regulator 166 and then adding three times the pressure of the dilution gas. This results in a reduction of the concentration of the sample gas to the desired level. In this example, the correct ration will be 1:3 volume sample to dilution gas.

The dilution assembly 104 has a three-way connection (T-connector) 182 (shown in FIGS. 5-8) fluidly coupled downstream of the first dual-stage gas regulator 166 and the second dual-stage gas regulator 168 and upstream from the diluted sample outlet 164. The three-way connection 182 receives the reduced pressure flow from each of the first dual-stage gas regulator 166 and the second dual-stage gas regulator 168 and combines the sample gas flow and dilution gas flow to allow the sample gas and dilution gas to mix. The three-way connection 182 then outputs the diluted gas sample downstream toward the diluted sample outlet 164. In other implementations, the dilution assembly 104 can include a mixing chamber downstream from the three-way connection 182 to allow the addition of other chemicals into the diluted gas sample. The three-way connection 182 is positioned within the first cavity 130 below the metal sheet 106.

The dilution assembly 104 includes two check valves 184a, 184b positioned between each of the first dual-stage gas regulator 166 and the second dual-stage gas regulator 168, respectively, and the three-way connection 182. The check valves 184a, 184b prevent back flow from the three-way connection 182 to the respective first dual-stage gas regulator 166 and the second dual-stage gas regulator 168. The two check valves 184a, 184b are positioned within the first cavity 130 below the metal sheet 106.

The dilution assembly 104 has control valves 186a-186g which are operable between an open and closed position to control the flow through the dilution assembly 104. The three-way connection 182 is positioned above the metal sheet 106 so they can be operated by the user. In this implementation, the control valves 186a-186g are manual valves (i.e., hand-operated or throttleable between an open and closed position to allow flow or stop flow). In other implementations, the control valves 186a-186g are automatically controlled by the controller to permit or secure flow in the dilution assembly 104.

The control valve 186a is fluidly coupled downstream from the sample gas inlet 158 and upstream from the first dual-stage gas regulator 166 to control flow of the sample gas from the sample gas inlet 158 to the first dual-stage gas regulator 166. The control valve 186a is operable to isolate flow from the sample gas inlet 158 to the first dual-stage gas regulator 166.

The control valve 186b is fluidly coupled downstream from the dilution gas inlet 160 and upstream from the second dual-stage gas regulator 168 to control flow of the dilution gas from the dilution gas inlet 160 to the second dual-stage gas regulator 168. The control valve 186b is operable to isolate flow from the dilution gas inlet 160 to the second dual-stage gas regulator 168.

The control valve 186c is fluidly coupled downstream from the first dual-stage gas regulator 166 and upstream from the check valve 184a to control flow of the sample gas from the first dual-stage gas regulator 166 to the three-way connection 182. The control valve 186c is operable to isolate flow from the reduced pressure sample gas to the three-way connection 182.

The control valve 186d is fluidly coupled downstream from the second dual-stage gas regulator 168 and upstream from the check valve 184b to control flow of the reduced pressure dilution gas from the second dual-stage gas regulator 168 to the three-way connection 182. The control valve 186d is operable to isolate flow from the reduced pressure dilution gas to the three-way connection 182.

The control valve 186e is fluidly coupled downstream from the three-way connection 182 and upstream from a vacuum pump 188 (described in more detail below) to control flow of the diluted gas sample to the vacuum pump 188. The control valve 186e is operable to isolate flow from the diluted gas sample to the vacuum pump 188.

The control valve 186f is fluidly coupled downstream from the three-way connection 182 and upstream from the diluted sample outlet 164 to control flow of the diluted gas sample out the diluted sample outlet 164. The control valve 186f is operable to isolate flow of the diluted gas sample out of the diluted sample outlet 164 and to a sample container 183 or measuring instrument.

The control valve 186g is fluidly coupled downstream from another three-way connection 190 fluidly coupled at an inlet 192 of the vacuum pump 188 and upstream from an internal vacuum inlet 194 to control flow of any leaked gases within the first cavity 130 into the vacuum pump 188. The control valve 186g is operable to isolate flow or allow flow of any leaked gases within the first cavity 130 to the vacuum pump 188.

The vacuum pump 188 is fluidly coupled to the dilution assembly 104 to evacuate a substance such as gases or particles from either the internal volume of the dilution assembly 104 or the internal sealed volume of the hand-portable case 102. The vacuum pump 188 can draw a suction on either the sealed volume of the first cavity 130 or the inner volume of the dilution assembly 104 based on the position of the control valve 186g. For example, when the control valve 186g is shut, the control valve 186e is open, one or more of the control valves 186a-f are open, and the vacuum pump 188 is operating, the gas, particulates, and/or contaminates can be evacuated from a portion of the dilution assembly 104. For example, when the control valve 186g is open, the control valve 186e is shut, and the vacuum pump 188 is operating, the gas, particulates, and/or contaminates can be evacuated from the first cavity 130 through the internal vacuum inlet 194.

The vacuum pump 188 is positioned within the hand-portable case 102 within the first cavity 130. The vacuum pump 188 has an outlet 196 extending outside the hand-portable case 102 to evacuate gas, particulates, and/or contaminates to a space outside the hand-portable case 102. The outlet 196 can be threaded to receive a hose to conduct the evacuated substances to another location or container to store the evacuated substances.

The vacuum pump 188 has an on/off switch 198 which is operable by the user to turn the vacuum pump 188 on and off. The on/off switch 198 is position on the outer side surfaces 118a of the hand-portable case 102. Referring to FIG. 3, the protective cover 116a is removably coupled to the outer side surface 118a to optionally protect the on/off switch 198 and the outlet 196 of the vacuum pump 188 from external contamination and impact.

Referring to FIG. 3, the vacuum pump 188 has an electrical connector 197 which is couplable to an electrical source to receive and conduct electrical power to the vacuum pump 188 to power the vacuum pump 188. In this implementation, the electrical connector 197 is a three-prong electrical connection, however, any suitable electrical connector may be used. The electrical connector 197 is positioned underneath the protective cover 116a. In this implementation, the electrical connector 197 can receive between 110-130 volts and between 50 hertz and 60 hertz electrical power, however, any suitable electrical power range may be used to power the vacuum pump 188. The vacuum pump 188 can be disconnected and removed from the dilution assembly 104 for repair or replacement.

Referring to FIG. 5, the dilution assembly 104 has multiple tubes 502 connecting one or more of the components of dilution assembly 104. The tubes 502 fluidly couple the components and conduct the sample gas, the dilution gas, or the diluted gas sample within the dilution assembly 104. The tubes 502 can handle high pressure and high temperature fluids. For example, the tubes 502 can have a high temperature limit of 350 degrees Fahrenheit (°F.). For example, the tubes 502 can have a high pressure limit of 2000 pounds per square inch (psi). The tubes 502 can be constructed from one or more of stainless steel, copper, braided metal, or a polymer.

The tubing 502 has a looped portion 504 coupled between the control valve 186a and the first dual-stage gas regulator 166 has a looped portion 506 between the control valve 186b and the second dual-stage gas regulator 168. When the high pressure sample gas flows through the looped portion 504 from the control valve 186a to the first dual-stage gas regulator 166, the looped portion 504 reduces a velocity and high speed collision of the sample gas molecules and particulates on system components, reducing component wear and increasing dilution assembly 104 life. When the high pressure dilution gas flows through the looped portion 506 from the control valve 186b to the first dual-stage gas regulator 166, the looped portion 504 reduces a velocity and high speed collision of the dilution gas molecules and particulates on system components, reducing component wear and increasing dilution assembly 104 life.

The tubing 502 has a U-shaped portion 508 between the control valve 186f and the diluted sample outlet 164. The U-shaped portion 508 can reduce the velocity of diluted gas sample to capture moisture in the diluted gas sample. Once the velocity of the sample is reduced by the U-shaped portion 508, the moisture being the heaviest in weight can settle in the U-shaped portion 508. The settled moisture can be evacuated from the U-shaped portion 508 with the vacuum pump 188.

The dilution assembly 104 has a humidity filter 510 downstream from the U-shaped portion 508 and upstream from the diluted sample outlet 164. The humidity filter 510 can capture moisture in the diluted gas sample, reducing the humidity of the diluted gas sample. The humidity filter 510 is removable from the dilution assembly 104. For example, the humidity filter 510 can be unscrewed from the dilution assembly 104 and replaced by a new humidity filter 510, decreasing the moisture contained within the dilution assembly 104. In some cases, the humidity filter can be replaced after a pre-determined time or number of uses. For example, the humidity filter can be replaced every fifty dilution cycles.

Referring to FIGS. 1 and 5, the dilution assembly 104 has a gas sensor 195 fluidly coupled between the first dual-stage gas regulator 166 and the control valve 186c. The gas sensor 195 senses a presence and level of a compound or element in the sample gas. For example, the gas sensor 195 can sense a toxic gas such as H₂S and visually or audibly alert the user to the presence of the toxic gas. The gas sensor 195 can also be fluidly coupled at different locations within the dilution assembly 104. For example, the gas sensor 195 could be positioned proximal the control valve 186, either upstream or downstream, to detect toxins in the sample gas between the sample gas inlet 158 and the control valve 186a or between the control valve 186a and the first dual-stage gas regulator 166.

The dilution assembly 104 includes a meter 193 positioned downstream from the control valve 186f and upstream from the U-shaped portion 508 to sense a condition of the diluted gas sample and visually alert the user to the condition of the diluted gas sample. The meter 193 can be one or more of a pressure meter or a flow rate meter.

The hand-portable gas sampling and dilution system 100 has a digital H₂S and lower explosive limit (LEL) sensor/alarm 191. The digital H₂S/LEL sensor 191 is positioned on the metal sheet 106 to alert the user of the presence of H₂S during sampling and diluting operations.

The hand-portable gas sampling and dilution system 100 has multiple accessories, tools, and spare parts positioned in the second cavity 132. The second cavity 132 is filled with foam to cushion and hold the accessories. The hand-portable gas sampling and dilution system 100 can include one or more flexible gas hoses 189 with the same or different fittings to couple to the inlets and outlets of the hand-portable gas sampling and dilution system 100 and the oilfield systems to be sampled.

The hand-portable gas sampling and dilution system 100 can include a power cord 187 positioned in the second cavity 132 to electrically couple the electrical connector 197 of the vacuum pump 188 to an external power source. The hand-portable gas sampling and dilution system 100 can include a power source 185 such as battery to power the vacuum pump 188 when the gas sampling site is remote an no external electrical power is readily available. The power source 185 can be positioned in the second cavity 132.

The hand-portable gas sampling and dilution system 100 can include one or more samples container 183 positioned in the second cavity 132 to receive and store the diluted gas sample. In some cases, the samples are positioned in dry ice reduce a temperature of the diluted gas sample.

The hand-portable gas sampling and dilution system 100 can include one or more or cleaning chemical containers 181 positioned in the second cavity 132 for additional cleaning of the dilution assembly 104. The cleaning chemicals can include deionized water and/or zinc acetate, however, any suitable cleaning chemical can be included. For example, cleaning chemicals can be suctioned from the cleaning chemical container 181 into the dilution assembly 104 by the vacuum pump 188 to flush contaminates from the dilution assembly 104.

The hand-portable gas sampling and dilution system 100 can include a manual H₂S measurement syringe 179 positioned in the second cavity 132. The manual H₂S measurement syringe 179 can be used to manually measure any corrosive or toxic gas in the sample gas before sampling the gas.

The hand-portable gas sampling and dilution system 100 can include extra control valves 186h positioned in the second cavity 132. The extra control valves 186h can be used to replace one or more of the control valves 186a-g if one or more of the control valves 186a-g becomes damaged or binds.

The hand-portable gas sampling and dilution system 100 can include extra fittings 177 positioned in the second cavity 132. The fittings 177 can be used with or without the flexible gas hoses 189 coupled to the dilution assembly 104 to the oilfield systems to be sampled, the samples container 183, dilution gas source 162, or cleaning chemical containers 181. For example, the fittings 177 can include a three inch to one half inch fitting, a two inch to one half inch fitting, a one inch to one half inch fitting, and a one quarter inch to one half inch fitting.

The hand-portable gas sampling and dilution system 100 can include extra humidity filters 510 positioned in the second cavity 132. The hand-portable gas sampling and dilution system 100 can include rolls of thread tape 175 positioned in the second cavity 132. The thread tape 175 can be used with the fittings 177 and the flexible gas hoses 189 to seal the dilution assembly 104 to the oilfield systems to be sampled, the samples container 183, dilution gas source 162, or cleaning chemical containers 181.

The hand-portable gas sampling and dilution system 100 can include wrenches 173 and pliers 171 positioned in the second cavity 132. The wrenches 173 and pliers 171 can be used to loosen and tighten the fittings 177, the flexible gas hoses 189, the samples container 183, the dilution gas source 162, and/or the cleaning chemical containers 181 to one another.

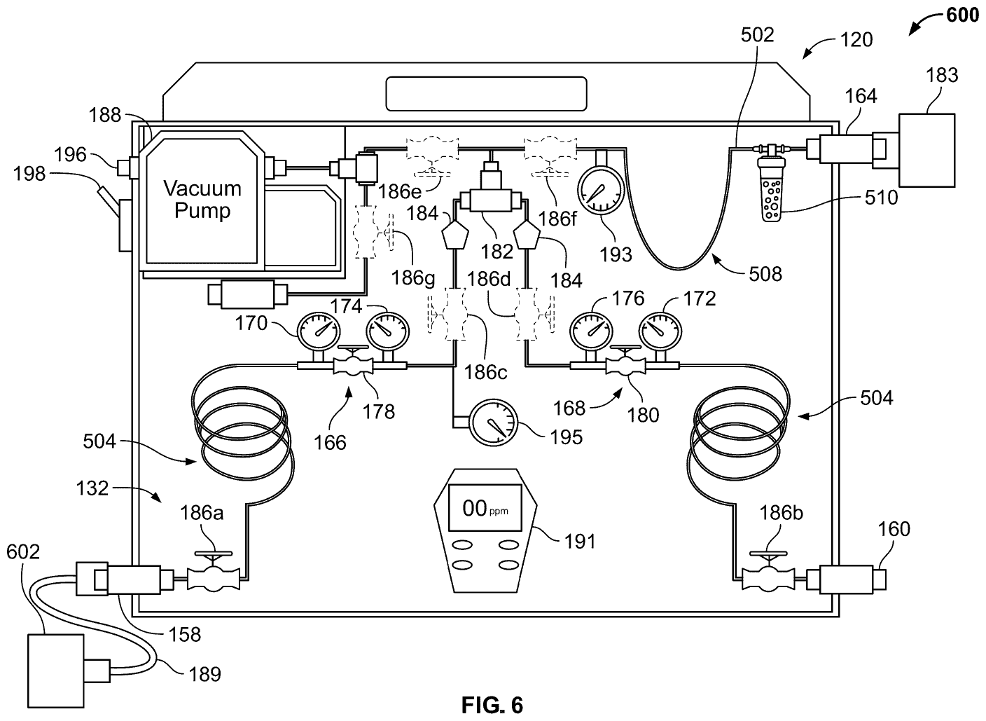

Referring to FIG. 6, the dilution assembly 104 is aligned to draw an undiluted gas sample. The sample gas inlet 158 is coupled to an oil field system 602 to be sampled. The control valve 186a is opened, the first dual-stage gas regulator 166 is set to reduce the pressure of the sample gas to a pre-selected pressure, the control valve 186c is opened, the control valve 186f is opened. All the other control valves 186b, 186d, 186e, and 186g are shut. The vacuum pump 188 is off. The undiluted reduced pressure sample gas flows into the sample container 183.

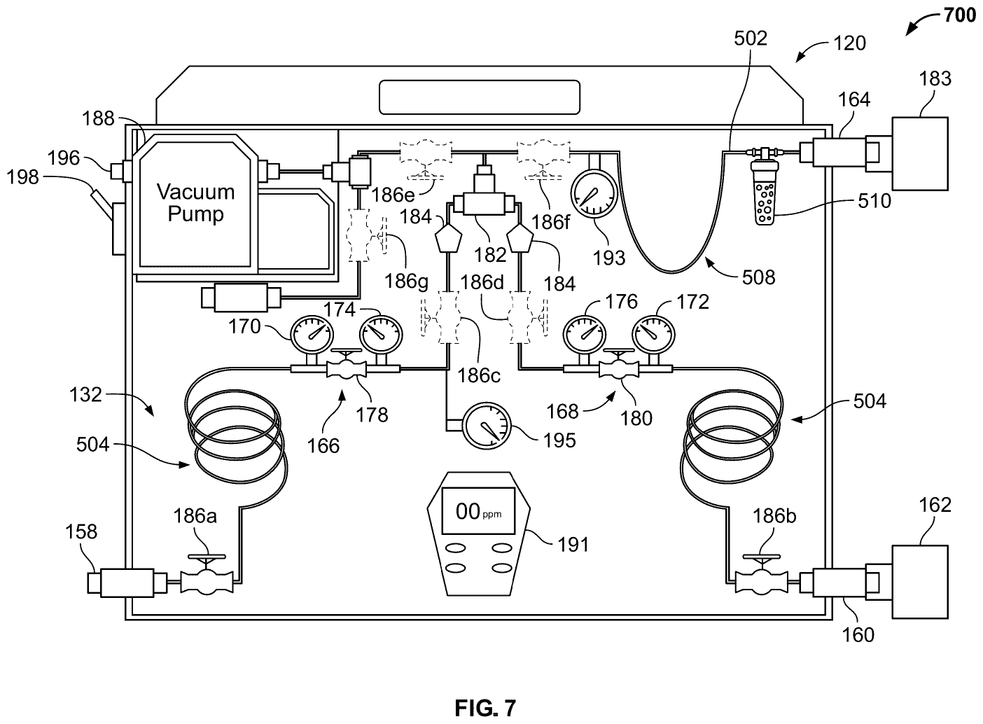

Referring to FIG. 7, the dilution assembly 104 is aligned to flow the dilution gas from the dilution gas source 162 to the sample container 183. The dilution gas source 162 is coupled to the dilution gas inlet 160. The control valve 186b is opened, the second dual-stage gas regulator 168 is set to reduce the pressure of the dilution gas to a pre-selected pressure, the control valve 186d is opened, the control valve 186f is opened. All the other control valves 186a, 186c, 186e, and 186g are shut. The vacuum pump 188 is off. The reduced pressure dilution gas flows into the sample container 183.

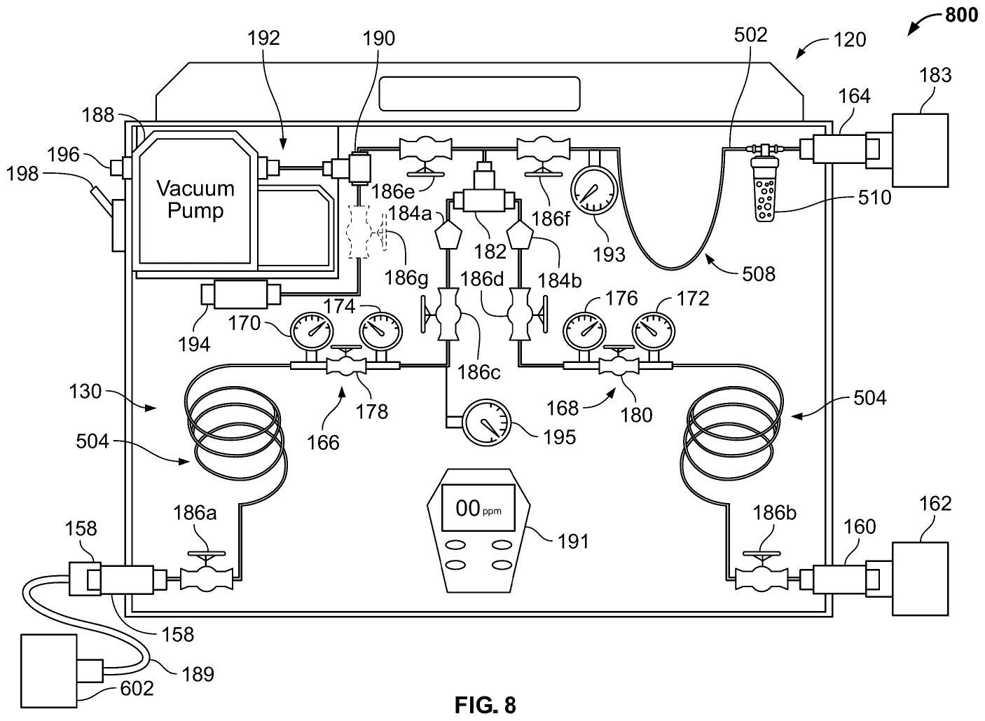

Referring to FIG. 8, the dilution assembly 104 is aligned to dilute the sample gas by a dilution ratio for sampling. The sample gas inlet 158 is coupled to the oil field system 602 to be sampled. The dilution gas source 162 is coupled to the dilution gas inlet 160. The sample container 183 is coupled to the diluted sample outlet 164. The first dual-stage gas regulator 166 is set to reduce the pressure of the sample gas to a pre-selected pressure. The second dual-stage gas regulator 168 is set to reduce the pressure of the dilution gas to a pre-selected pressure. The control valves 186e, and 186g are shut. The vacuum pump 188 is off. The control valves 186a, 186b, 186c, 186d, and 186f are opened. The sample gas flows from the oil field system 602 to the first dual-stage gas regulator 166 where the pressure of the sample gas is reduced to the pre-selected pressure. The dilution gas flows to the second dual-stage gas regulator 168 where the pressure of the dilution gas is reduced to the pre-selected pressure. The reduced pressure sample gas and the reduced pressure dilution gas flow to the three-way connection 182 where they are mixed. The diluted sample gas then flows through the control valve 186f, some or all of the remaining moisture is removed by the U-shaped portion 508 and the humidity filter 510, and dry reduced pressure diluted gas sample exits the dilution assembly 104 through the diluted sample outlet 164 and enters the sample container 183. The control valves 186a, 186b, 186c, 186d, and 186f are shut and the sample container 183 can then be disconnected from the dilution assembly 104 for further measurement. In other implementations, the sample container 183 can be replaced with a field sensor or instrument and the diluted gas sample can be directly measured.

The dilution assembly 104 can be evacuated using the vacuum pump. In one instance, the vacuum pump 188 is electrically powered by the connecting the external power source 185 to the power cord 187, and the power cord 187 is then connected to the electrical connector (shown in FIG. 3). One or more, or all of the control valves 186a-e are opened. The control valve 186g is shut. The on/off switch 198 is moved from the off position to the on position, and the vacuum pump 188 is energized, generating a suction force on the dilution assembly 104 and removing any gases or contaminates from the dilution assembly 104 and out the outlet 196. When all the control valves 186a-e are open, the dilution assembly 104 is flushed with surrounding air. The on/off switch 198 is moved from the on position to the off position, deenergizing the vacuum pump 188. In another arrangement, the dilution gas source 162 can be coupled to one or more of the sample gas inlet 158, the dilution gas inlet 160, or the diluted sample outlet 264 to flush the dilution assembly 104 with the dilution gas. The cleaning chemical container 181 can be coupled to one or more of the sample gas inlet 158, the dilution gas inlet 160, or the diluted sample outlet 264 to flush the dilution assembly 104 with the cleaning chemical.

In another instance, the vacuum pump 188 can evacuate any contaminants or gases that have entered the sealed volume of the first cavity 130 during sampling and diluting operations. For example, the vacuum pump 188 is electrically powered by connecting the external power source 185 to the power cord 187, and the power cord 187 is then connected to the electrical connector (shown in FIG. 3). One or more, or all of the control valves 186a-e are shut. The control valve 186g is opened. The on/off switch 198 is moved from the off position to the on position, and the vacuum pump 188 is energized, generating a suction force within the first cavity 130 by evacuating the first cavity 130 through the internal vacuum inlet 194, the control valve 186g, into the vacuum pump 188, and out the vacuum pump outlet 196.

The previous operations have been described as manual operations performed by the user, however, one or more of these operations can be automated using the controller and pre-selected values and thresholds to sense and produce the diluted gas sample. For example, when the hand-portable gas sampling and dilution system 100 includes the controller, the controller generates command signals to open and close one or more of the control valves 186a-g, the first and second dual-stage gas regulators 166, 168, and the vacuum pump 188 to produce the diluted gas sample, clean the dilution assembly 104, or evacuate the first cavity 130.

In other embodiment, a gas dilution system is man-portable and is operable to produce a diluted gas sample in the oilfield. The gas dilution system has a man-portable clamshell case and a gas dilution assembly contained within the man-portable clamshell case.

The man-portable clamshell case has a first portion and a second portion. The first portion and the second portion seal together to define a vacuum sealable volume. The man-portable clamshell case has a plastic cover and a metal liner.

The gas dilution assembly is positioned in the first portion of the man-portable clamshell case. The gas dilution assembly mixes a dilution gas with a sample gas to form a diluted sample. The gas dilution assembly has a sample gas inlet extending through the first portion of the man-portable clamshell case to a space outside the man-portable clamshell case, a dilution gas inlet extending through the first portion of the man-portable clamshell case to the space outside the man-portable clamshell case, a diluted sample outlet extending through the first portion of the man-portable clamshell case to the space outside the man-portable clamshell case, a vacuum pump evacuate a substance from one or both of the gas dilution assembly and the man-portable clamshell case, and a pressure balance button extending through the first portion of the man-portable clamshell case to the space outside the man-portable clamshell case. The vacuum pump includes an on/off switch, an electrical connection, and a vacuum outlet. The on/off switch is positioned on an outer surface of the man-portable clamshell case. The electrical connection extends through the first portion of the man-portable clamshell case to the space outside the man-portable clamshell case and supplies electrical power to the vacuum pump. The vacuum outlet extends through the first portion of the man-portable clamshell case to the space outside the man-portable clamshell case.

In some implementations, the gas dilution system includes at least one handle coupled to the man-portable clamshell case. In some implementations, the at least one handle is extendable. In some implementations, the gas dilution system includes a pair of wheels coupled to the man-portable clamshell case opposite the at least one handle.

In yet other embodiment, an oilfield gas dilution kit produces a diluted gas sample. The oilfield gas dilution kit has a vacuum-sealable hard case having maximum dimensions of an exterior length of thirty-five inches, an exterior width of twenty-seven and a half inches, and an exterior height of fourteen inches. The oilfield gas dilution kit has a carry handle coupled to the vacuum-sealable hard case. The oilfield gas dilution kit has a retractable handle coupled to the vacuum-sealable hard case. The oilfield gas dilution kit has a pair of wheels coupled to the vacuum-sealable hard case opposite the carry handle and the retractable handle. The oilfield gas dilution kit has a maximum total weight of the oilfield gas dilution kit is less than or equal to 30 pounds.

The oilfield gas dilution kit has a gas dilution system positioned in the vacuum-sealable hard case and coupled to a first inner surface of the vacuum-sealable hard case. The gas dilution system receives a dilution gas, receive a sample gas, and mix the dilution gas with the sample gas to form the diluted gas sample. The oilfield gas dilution kit has a vacuum pump coupled to the gas dilution system. The oilfield gas dilution kit has a sample chamber to receive the diluted gas sample. The sample chamber is coupled to an outer surface of the vacuum-sealable hard case.

The oilfield gas dilution kit has a gas monitor with an alarm. The gas monitor is positioned on the first inner surface in the vacuum-sealable hard case. The oilfield gas dilution kit has a manual H₂S measurement syringe positioned on a second inner surface in the vacuum-sealable hard case.

The oilfield gas dilution kit has one or more replacement valves positioned on the second inner surface of the vacuum-sealable hard case, a power supply to couple and supply power to the vacuum pump positioned on the second inner surface in the vacuum-sealable hard case, one or more replacement humidity filters positioned on the second inner surface in the vacuum-sealable hard case, a multiple fittings and connections positioned on the second inner surface in the vacuum-sealable hard case, one or more filter fittings positioned on the second inner surface in the vacuum-sealable hard case, one or more rolls of thread seal tape positioned on the second inner surface in the vacuum-sealable hard case, one or more sampling hoses positioned on the second inner surface in the vacuum-sealable hard case, and one or more wrenches positioned on the second inner surface in the vacuum-sealable hard case.

As used herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As used herein, the term “approximately” refers to a condition or parameter which can have a value or threshold value generally within acceptable engineering, machining, measurement, or manufacturing tolerances. For example, the parameter value or threshold value can be considered approximately met when the value is within 5% of the actual parameter value or threshold value. For example, the parameter value can be considered to be equal to the threshold value when the parameter value is within 5% of the threshold value. However, different approximations for different parameter values or threshold values may be used in different embodiments.

### EMBODIMENTS

In an example aspect, a hand-portable gas sampling and dilution system includes a hand-portable case and a dilution system. The hand-portable case has a first side and a second side hingedly coupled to the first side. The hand-portable case has a carry handle with a first portion and a second portion. The first portion is coupled to the first side of the hand-portable case and the second portion coupled to the second side of the hand-portable case. The first portion and the second portion mate when the first side and second side are closed together. The hand-portable case has a retractable handle coupled to the first side proximal the carry handle. The hand-portable case has a pair of wheels couple to the hand-portable case opposite the carry handle and the retractable handle. The dilution system is positioned in the hand-portable case and coupled an inner surface of the first side. The dilution system mixes a dilution gas with a sample gas to form a diluted sample.

In an example aspect combinable with any other example aspect, the dilution system includes a diluted sample outlet to couple to a gas analyzer or gas container.

In an example aspect combinable with any other example aspect, the dilution system includes a sample gas inlet to receive the sample gas.

In an example aspect combinable with any other example aspect, the dilution system includes a dilution gas inlet to receive to the dilution gas.

In an example aspect combinable with any other example aspect, the dilution system includes a first dual-stage gas regulator and a second dual-stage gas regulator. The first dual-stage gas regulator is coupled to the sample gas inlet. The first dual-stage gas regulator controls a flow of the sample gas and provide the controlled flow of the sample gas to the diluted sample outlet. The second dual-stage gas regulator is coupled to the dilution gas inlet. The second dual-stage gas regulator controls a flow of the dilution gas and provides the controlled flow of the dilution gas to the diluted sample outlet.

In an example aspect combinable with any other example aspect, the first dual-stage gas regulator and the second dual-stage gas regulator control a pressure of the diluted sample.

In an example aspect combinable with any other example aspect, the first dual-stage gas regulator and the second dual-stage gas regulator control a ratio of the sample gas to the dilution gas at the diluted sample outlet.

In an example aspect combinable with any other example aspect, the dilution system has multiple tubes connecting components of dilution system.

In an example aspect combinable with any other example aspect, the dilution system includes a vacuum pump coupled downstream from the first dual-stage gas regulator and the second dual-stage gas regulator. The vacuum pump evacuates a substance from the dilution system.

In an example aspect combinable with any other example aspect, the vacuum pump includes an on/off switch position on an outer surface of the hand-portable case.

In an example aspect combinable with any other example aspect, the vacuum pump includes an outlet to remove the substance from the dilution system to a space outside the hand-portable case.

In an example aspect combinable with any other example aspect, the dilution system includes a vacuum inlet coupled i) downstream from the first and second dual-stage gas pressure regulators and ii) at a suction of the vacuum pump within the hand-portable case.

In an example aspect combinable with any other example aspect, the hand-portable case has an internal metal boundary.

In an example aspect combinable with any other example aspect, the hand-portable case is vacuum sealable.

In an example aspect combinable with any other example aspect, the hand-portable gas sampling and dilution system includes a pair of anti-vibration legs positioned on the first side.

In an example aspect combinable with any other example aspect, the hand-portable gas sampling and dilution system includes a humidity filter coupled upstream from the diluted sample outlet.

In an example aspect combinable with any other example aspect, the hand-portable gas sampling and dilution system includes a U-shaped tube coupled upstream from the humidity filter, the U-shaped tube to trap reduce a humidity of the diluted sample.

In another example aspect, a gas dilution system includes a man-portable clamshell case, a gas dilution assembly, and a pressure balance button. The man-portable clamshell case has a first portion and a second portion. The first portion and the second portion seal together to define a vacuum sealable volume. The man-portable clamshell case includes a plastic cover and a metal liner. The gas dilution assembly is positioned in the first portion of the man-portable clamshell case. The gas dilution assembly mixes a dilution gas with a sample gas to form a diluted sample. The gas dilution assembly has a sample gas inlet, a dilution gas inlet, a diluted sample outlet, and a vacuum pump. The sample gas inlet extends from the first portion of the man-portable clamshell case to a space outside the man-portable clamshell case. The dilution gas inlet extends through the first portion of the man-portable clamshell case to the space outside the man-portable clamshell case. The diluted sample outlet extends through the first portion of the man-portable clamshell case to the space outside the man-portable clamshell case. The vacuum pump evacuates a substance from one or both of the gas dilution assembly and the man-portable clamshell case. The vacuum pump has an on/off switch, an electrical connection, and a vacuum outlet. The on/off switch is positioned on an outer surface of the man-portable clamshell case. The electrical connection extends through the first portion of the man-portable clamshell case to the space outside the man-portable clamshell case. The electrical connection supplies electrical power to the vacuum pump. The vacuum outlet extends through the first portion of the man-portable clamshell case to the space outside the man-portable clamshell case. The pressure balance button extends through the first portion of the man-portable clamshell case to the space outside the man-portable clamshell case.

In an example aspect combinable with any other example aspect, the gas dilution system includes at least one handle coupled to the man-portable clamshell case and a pair of wheels coupled to the man-portable clamshell case opposite the at least one handle.

In another example aspect, an oilfield gas dilution kit produces a diluted gas sample. The oilfield gas dilution kit includes a vacuum-sealable hard case, a carry handle, a retractable handle, a pair of wheels, a gas dilution system, a vacuum pump, a sample chamber, a gas monitor, a manual H₂S measurement syringe, one or more replacement valves, a power supply, one or more replacement humidity filters, multiple fittings and connections, one or more rolls of thread seal tape, one or more sampling hoses, and one or more wrenches. The vacuum-sealable hard case has maximum dimensions of an exterior length of thirty-five inches, an exterior width of twenty-seven and a half inches, and an exterior height of fourteen inches. The carry handle is coupled to the vacuum-sealable hard case. The retractable handle is coupled to the vacuum-sealable hard case. The pair of wheels is coupled to the vacuum-sealable hard case opposite the carry handle and the retractable handle. The gas dilution system is positioned in the vacuum-sealable hard case and coupled to a first inner surface of the vacuum-sealable hard case. The gas dilution system receives a dilution gas, receive a sample gas, and mixes the dilution gas with the sample gas to form the diluted gas sample. The vacuum pump is coupled to the gas dilution system. The sample chamber receives the diluted gas sample and is coupled to an outer surface of the vacuum-sealable hard case. The gas monitor has an alarm and is positioned on the first inner surface in the vacuum-sealable hard case. The manual H₂S measurement syringe is positioned on a second inner surface in the vacuum-sealable hard case. The replacement valves are positioned on the second inner surface of the vacuum-sealable hard case. The power supply is coupled to the vacuum pump and supplies power to the vacuum pump which is positioned on the second inner surface in the vacuum-sealable hard case. The replacement humidity filters are positioned on the second inner surface in the vacuum-sealable hard case. The fittings and connections are positioned on the second inner surface in the vacuum-sealable hard case. The filter fittings are positioned on the second inner surface in the vacuum-sealable hard case. The rolls of thread seal tape are positioned on the second inner surface in the vacuum-sealable hard case. The sampling hoses are positioned on the second inner surface in the vacuum-sealable hard case. The wrenches are positioned on the second inner surface in the vacuum-sealable hard case. A maximum total weight of the oilfield gas dilution kit is less than or equal to 30 pounds.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

1. A hand-portable gas sampling and dilution system comprising:
a hand-portable case, the hand-portable case comprising:
a first side;
a second side hingedly coupled to the first side;
a carry handle having a first portion and a second portion, the first portion coupled to the first side of the hand-portable case and the second portion coupled to the second side of the hand-portable case, the first portion and the second portion mating when the first side and second side are closed together; and
a retractable handle coupled to the first side proximal the carry handle;
a pair of wheels couple to the hand-portable case opposite the carry handle and the retractable handle; and
a dilution system positioned in the hand-portable case and coupled an inner surface of the first side, the dilution system configured to mix a dilution gas with a sample gas to form a diluted sample.

2. The hand-portable gas sampling and dilution system of claim 1, wherein the dilution system comprises a diluted sample outlet configured to couple to a gas analyzer or gas container.

3. The hand-portable gas sampling and dilution system of claim 2, wherein the dilution system comprises a sample gas inlet configured to receive the sample gas.

4. The hand-portable gas sampling and dilution system of claim 3, wherein the dilution system comprises a dilution gas inlet configured to receive to the dilution gas.

5. The hand-portable gas sampling and dilution system of claim 4, wherein the dilution system comprises:
a first dual-stage gas regulator coupled to the sample gas inlet, the first dual-stage gas regulator configured to control a flow of the sample gas and provide the controlled flow of the sample gas to the diluted sample outlet; and
a second dual-stage gas regulator coupled to the dilution gas inlet, the second dual-stage gas regulator configured to control a flow of the dilution gas and provide the controlled flow of the dilution gas to the diluted sample outlet.

6. The hand-portable gas sampling and dilution system of claim 5, wherein the first dual-stage gas regulator and the second dual-stage gas regulator are further configured to control a pressure of the diluted sample.

7. The hand-portable gas sampling and dilution system of claim 5, wherein the first dual-stage gas regulator and the second dual-stage gas regulator are further configured to control a ratio of the sample gas to the dilution gas at the diluted sample outlet.

8. The hand-portable gas sampling and dilution system of claim 5, wherein the dilution system comprises a plurality of tubes connecting components of dilution system.

9. The hand-portable gas sampling and dilution system of claim 5, wherein the dilution system further comprises a vacuum pump coupled downstream from the first dual-stage gas regulator and the second dual-stage gas regulator, the vacuum pump configured to evacuate a substance from the dilution system.

10. The hand-portable gas sampling and dilution system of claim 9, wherein the vacuum pump comprises an on/off switch position on an outer surface of the hand-portable case.

11. The hand-portable gas sampling and dilution system of claim 9, wherein the vacuum pump comprises an outlet configured to remove the substance from the dilution system to a space outside the hand-portable case.

12. The hand-portable gas sampling and dilution system of claim 9, wherein the dilution system further comprises a vacuum inlet coupled i) downstream from the first and second dual-stage gas pressure regulators and ii) at a suction of the vacuum pump within the hand-portable case.

13. The hand-portable gas sampling and dilution system of claim 1, wherein the hand-portable case comprises an internal metal boundary.

14. The hand-portable gas sampling and dilution system of claim 13, wherein the hand-portable case is configured to be vacuum sealable.

15. The hand-portable gas sampling and dilution system of claim 1, further comprising a pair of anti-vibration legs positioned on the first side.

16. The hand-portable gas sampling and dilution system of claim 2, further comprising a humidity filter coupled upstream from the diluted sample outlet.

17. The hand-portable gas sampling and dilution system of claim 16, further comprising a U-shaped tube coupled upstream from the humidity filter, the U-shaped tube configured to trap reduce a humidity of the diluted sample.

18. A gas dilution system comprising:
a man-portable clamshell case having a first portion and a second portion, the first portion and the second portion configured to seal together to define a vacuum sealable volume, the man-portable clamshell case comprising:
a plastic cover; and
a metal liner;
a gas dilution assembly positioned in the first portion of the man-portable clamshell case, the gas dilution assembly configured to mix a dilution gas with a sample gas to form a diluted sample, the gas dilution assembly comprising:
a sample gas inlet extending through the first portion of the man-portable clamshell case to a space outside the man-portable clamshell case;
a dilution gas inlet extending through the first portion of the man-portable clamshell case to the space outside the man-portable clamshell case;
a diluted sample outlet extending through the first portion of the man-portable clamshell case to the space outside the man-portable clamshell case;
a vacuum pump configured to evacuate a substance from one or both of the gas dilution assembly and the man-portable clamshell case, the vacuum pump comprising:
an on/off switch position on an outer surface of the man-portable clamshell case;
an electrical connection extending through the first portion of the man-portable clamshell case to the space outside the man-portable clamshell case, the electrical connection configured to supply electrical power to the vacuum pump; and
a vacuum outlet extending through the first portion of the man-portable clamshell case to the space outside the man-portable clamshell case; and
a pressure balance button extending through the first portion of the man-portable clamshell case to the space outside the man-portable clamshell case.

19. The gas dilution system of claim 18, further comprising
at least one handle coupled to the man-portable clamshell case; and
a pair of wheels coupled to the man-portable clamshell case opposite the at least one handle.

20. An oilfield gas dilution kit configured to produce a diluted gas sample, the oilfield gas dilution kit comprising:
a vacuum-sealable hard case having maximum dimensions of an exterior length of thirty-five inches, an exterior width of twenty-seven and a half inches, and an exterior height of fourteen inches;
a carry handle coupled to the vacuum-sealable hard case;
a retractable handle coupled to the vacuum-sealable hard case;
a pair of wheels coupled to the vacuum-sealable hard case opposite the carry handle and the retractable handle;
a gas dilution system positioned in the vacuum-sealable hard case and coupled to a first inner surface of the vacuum-sealable hard case, the gas dilution system configured to receive a dilution gas, receive a sample gas, and mix the dilution gas with the sample gas to form the diluted gas sample;
a vacuum pump coupled to the gas dilution system;
a sample chamber configured to receive the diluted gas sample, the sample chamber coupled to an outer surface of the vacuum-sealable hard case;
a gas monitor comprising an alarm, the gas monitor positioned on the first inner surface in the vacuum-sealable hard case;
a manual H₂S measurement syringe positioned on a second inner surface in the vacuum-sealable hard case;
one or more replacement valves positioned on the second inner surface of the vacuum-sealable hard case;
a power supply configured to couple and supply power to the vacuum pump positioned on the second inner surface in the vacuum-sealable hard case;
one or more replacement humidity filters positioned on the second inner surface in the vacuum-sealable hard case;
a plurality of fittings and connections positioned on the second inner surface in the vacuum-sealable hard case;
one or more filter fittings positioned on the second inner surface in the vacuum-sealable hard case;
one or more rolls of thread seal tape positioned on the second inner surface in the vacuum-sealable hard case;
one or more sampling hoses positioned on the second inner surface in the vacuum-sealable hard case;
one or more wrenches positioned on the second inner surface in the vacuum-sealable hard case; and
wherein a maximum total weight of the oilfield gas dilution kit is less than or equal to 30 pounds.
